(19) United States
(12) Patent Application Publication
(10) Pub. No.: US 2018/0119812 A1
(43) Pub. Date: May 3, 2018

(54) Traction Path Oil Control For A Ball Variator Continuosly Variable Transmission

(71) Applicant: Dana Limited, Maumee, OH (US)

(72) Inventors: Joseph J. Horak, Austin, TX (US); Michael E. Stone, Cedar Park, TX (US)

(21) Appl. No.: 15/858,123

(22) Filed: Dec. 29, 2017

Related U.S. Application Data
(60) Provisional application No. 62/587,551, filed on Nov. 17, 2017.

(51) Int. Cl. F16H 61/664; F16H 63/06; F16H 63/42; F16H 59/40; F16H 37/08; F16H 15/50; F16H 25/22

(52) U.S. Cl. CPC F16H 61/6645; F16H 63/067; F16H 63/42; F16H 2045/0215; F16H 37/084; F16H 15/506; F16H 25/229; F16H 59/40

(57) ABSTRACT

Provided herein is a variator including: a first traction ring assembly and a second traction ring assembly in contact with a plurality of balls, wherein each ball of the plurality of balls has a tiltable axis of rotation; and a traction patch oil control member coupled to the first and/or second traction ring assembly.

### RELATED APPLICATION

This application claims the benefit of U.S. Provisional Patent Application No. 62/587,551, filed Nov. 17, 2017, which is incorporated herein by reference in its entirety.

### BACKGROUND

A driveline including a continuously variable transmission allows an operator or a control system to vary a drive ratio in a stepless manner, permitting a power source to operate at its most advantageous rotational speed.

### SUMMARY

Provided herein is a variator including: a first traction ring assembly and a second traction ring assembly in contact with a plurality of balls, wherein each ball of the plurality of balls has a tiltable axis of rotation; and a traction patch oil control member coupled to the first and/or second traction ring assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that is used in the ball-type variator of FIG. 1.

FIG. 3 is an illustrative view of different tilt positions of the ball-type variator of FIG. 1.

FIG. 4 is a schematic illustration of a preferred embodiment of a variator having traction patch oil control member.

FIG. 5 is a plan view of the traction patch oil control member of FIG. 4.

FIG. 6 is a schematic illustration of another preferred embodiment a variator having traction patch oil control member.

### DETAILED DESCRIPTION OF THE PREFERRED EMBODIMENTS

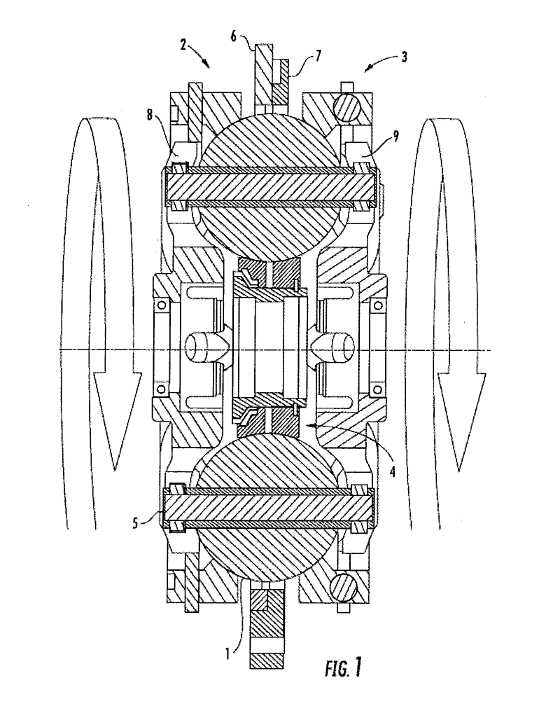

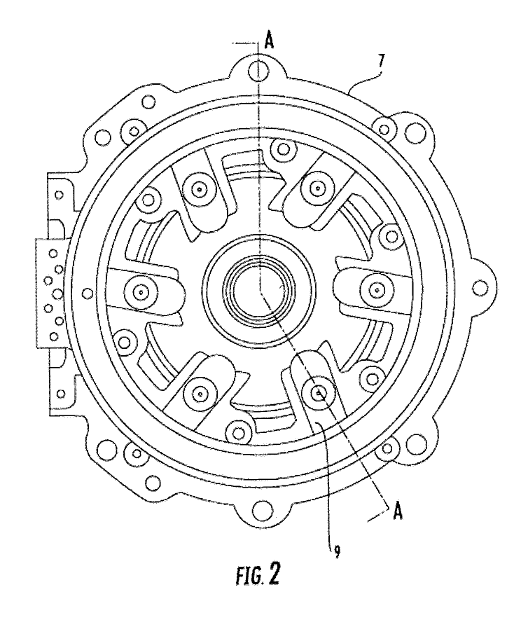

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the preferred embodiments includes several novel features, no single one of which is solely responsible for its desirable attributes or which is essential to practicing the embodiments described. Provided herein are configurations of continuously variable transmissions (CVTs) based on a ball-type variators, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface in contact with the balls, an input (first) traction ring 2, an output (second) traction ring 3, and an idler (sun) assembly 4 as shown on FIG. 1. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. In some embodiments, the CVT can be provided with a rotatable main shaft that is substantially aligned with a longitudinal axis of the CVT. In some embodiments, the variator is coaxial with the rotatable shaft. Other types of ball CVTs also exist, but are slightly different.

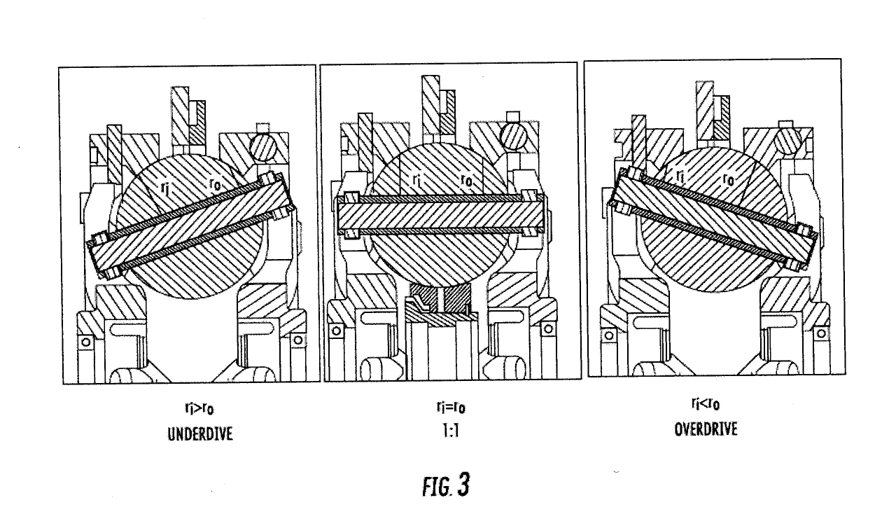

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments disclosed here are related to the control of a variator and/or a CVT using generally spherical planets each having a tiltable axis of rotation that are adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

As used here, the terms “operationally connected,” “operationally coupled”, “operationally linked”, “operably connected”, “operably coupled”, “operably linked,” “operably coupleable” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling take a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these are typically understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here operate in both tractive and frictional applications. For example, in the embodiment where a CVT is used for a bicycle application, the CVT operates at times as a friction drive and at other times as a traction drive, depending on the torque and speed conditions present during operation.

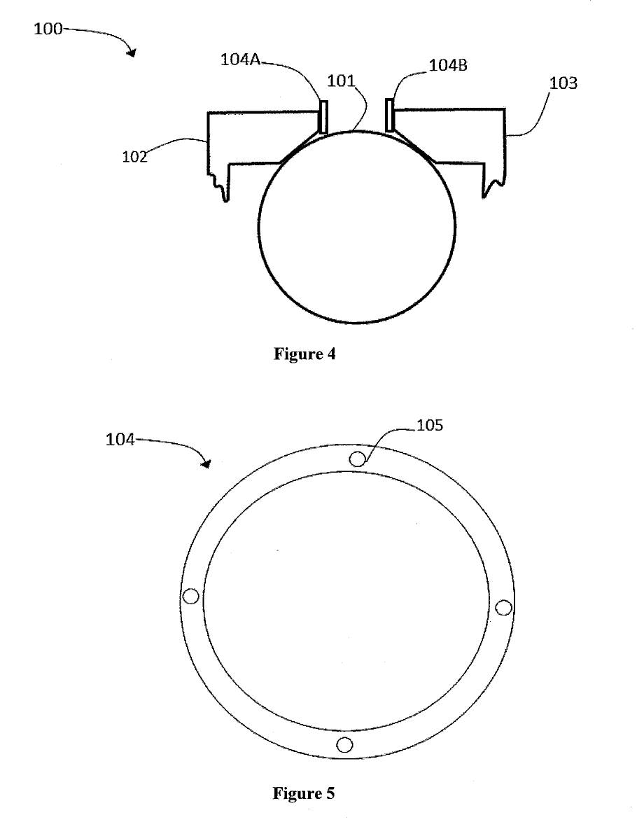

Referring now to FIGS. 4 and 5, in some embodiments, a variator 100 is similar to the variator depicted in FIGS. 1-3. For description purposes, only the differences between the variator 100 and the variator of FIGS. 1-3 will be described. The variator 100 includes a number of balls 101 arrayed about a main axis. A first traction ring assembly 102 and a second traction ring assembly 103 are in contact with each ball at a contacting location referred to herein as a “traction contact patch” or a “contact patch”. In some embodiments, a traction patch oil control member 104 is coupled to the first traction ring assembly 102. The traction patch oil control member 104A is positioned on the first traction ring assembly 102 in proximity to the contact patch of the first traction ring assembly 102 and the ball 101. The traction patch oil control member 104A is positioned to impede an exiting traction fluid from the contact patch of the first traction ring assembly 102 and the ball 101. In some embodiments, the traction patch oil control member 104A touches the surface of the ball 101. In other embodiments, the traction patch oil control member 104A does not contact the surface of the ball 101 directly. In some embodiments, the second traction ring assembly 103 is coupled to a traction patch oil control member 104B. In some embodiments, the traction patch oil control member 104 is a generally annular ring. In some embodiments, the traction patch oil control member 105 is provided with an array of fastening bores adapted to couple the traction patch oil control member 104 to the first traction ring assembly 103, for example. In other embodiments, the traction patch oil control member 104 is integral to the first traction ring assembly 103.

During operation of the variator 100, the traction oil control member 104 blocks the passage of oil due to centrifugal forces that tend to shed oil from the traction patch and reduce fluid film thickness. Maintaining more fluid in the traction patch to thereby increase fluid film thickness, improves durability and thermal control of the variator 100. The traction oil control members 104 are able to control the flow of traction oil in the traction contact because of the traction oil control members 104 are coupled directly to the traction ring assemblies 102, 103. This is an improvement over previous designs, such as those described in U.S. Pat. No. 9,388,884, which is hereby incorporated by reference.

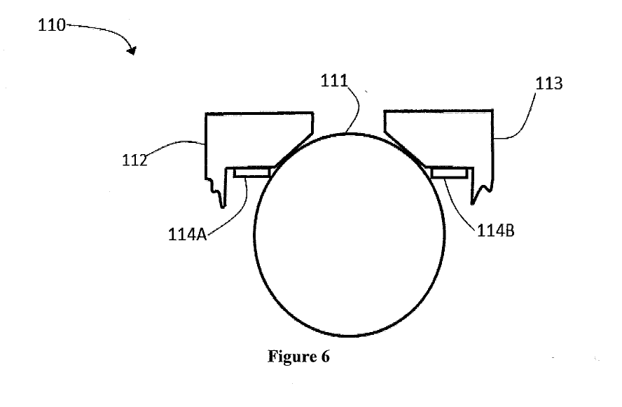

Referring now to FIG. 6, in some embodiments, a variator 110 is similar to the variator depicted in FIGS. 1-3. For description purposes, only the differences between the variator 110 and the variator of FIGS. 1-3 will be described. The variator 110 includes a number of balls 111 arrayed about a main axis. A first traction ring assembly 112 and a second traction ring assembly 113 are in contact with each ball at a contacting location referred to herein as a “traction contact patch” or a “contact patch”. In some embodiments, a traction patch oil control member 114 is coupled to the first traction ring assembly 112. The traction patch oil control member 114A is positioned radially inward of the traction contact between the first traction ring assembly 112 and the ball 111. In some embodiments, the traction patch oil control member 114A is positioned in proximity to the contact patch of the first traction ring assembly 112 and the ball 111. The traction patch oil control member 114A is positioned to impede a traction fluid from exiting the contact patch of the first traction ring assembly 112 and the ball 111. In some embodiments, the traction patch oil control member 114A touches the surface of the ball 111. In other embodiments, the traction patch oil control member 114A does not contact the surface of the ball 111 directly. In some embodiments, the second traction ring assembly 113 is coupled to a traction patch oil control member 114B. In some embodiments, the traction patch oil control member 114 is a generally annular ring configured to fasten to either the first traction ring assembly 112 or the second traction ring assembly 113.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practice. It is intended that the following claims define the scope of the preferred embodiments and that methods and structures within the scope of these claims and their equivalents be covered thereby.

What is claimed is:

1. A variator comprising:
a first traction ring assembly and a second traction ring assembly in contact with a plurality of balls, wherein each ball of the plurality of balls has a tiltable axis of rotation; and
a traction patch oil control member coupled to the first traction ring assembly.

2. The variator of claim 1, wherein the traction patch oil control member is an annular ring.

3. The variator of claim 1, wherein the traction patch oil control member is positioned to impede a traction fluid exiting a contact location between the first traction ring assembly and the ball.

4. The variator of claim 1, wherein the traction patch oil control member is integral with the first traction ring assembly.

5. The variator of claim 1, wherein the traction patch oil control member is fastened to the first traction ring assembly with a plurality of fasteners.
